(19) United States
(12) Patent Application Publication
(10) Pub. No.: US 2020/0065422 A1
(43) Pub. Date: Feb. 27, 2020

(54) Document Entity Linking on Online Social Networks

(71) Applicant: Facebook, Inc., Menlo Park, CA (US)

(72) Inventors: Xiaohua Yan, Fremont, CA (US); Bi Xue, Foster City, CA (US); Jeevan Shankar, Sunnyvale, CA (US); Rajesh Krishna Shenoy, Cupertino, CA (US); Jingfei Du, Foster City, CA (US); Mohammad Javad Dousti, Menlo Park, CA (US); Veselin S. Stoyanov, Menlo Park, CA (US)

(21) Appl. No.: 16/112,477

(22) Filed: Aug. 24, 2018

(51) Int. Cl. G06F 17/30; G06Q 50/00; G06N 99/00; G06N 5/02

(52) U.S. Cl. CPC G06F 17/30867; G06N 5/022; G06N 99/005; G06Q 50/01

(57) ABSTRACT

In one embodiment, a method includes accessing a document, identifying one or more noun phrases in the document by performing a pre-processing on the accessed document, generating, for each identified noun phrase, a list of candidate entities corresponding to the noun phrase, wherein the list of candidate entities is looked up in an entity index using the noun phrase, computing, for each candidate entity corresponding to each identified noun phrase, a confidence score that the noun phrase is intended to reference the candidate entity by analyzing the accessed document by a machine learning model, constructing a pool of mention-entity pairs for the accessed document, filtering the pool of mention-entity pairs by removing each mention-entity pair from the pool based on their computed confidence scores, and storing the post-filtered pool of mention-entity pairs in a data store in association with the accessed document.

### TECHNICAL FIELD

This disclosure generally relates to databases and file management within network environments, and in particular relates to performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, the social-networking system may identify name strings, also called as “mentions”, referring to entities in a document. The social-networking system may link the identified mentions to the most appropriate corresponding entities for use in resolving search queries. A mention and a corresponding entity may not always be one-to-one mapped. An entity may be referred to by various names (i.e., a many-to-one mapping). As an example and not by way of limitation, New York City may be called by ‘New York City,’ ‘New York,’ ‘NY,’ ‘NYC,’ or even by ‘the Big Apple.’ Furthermore, a mention may be linked to more than one entity (i.e., a one-to-many mapping). As an example and not by way of limitation, a mention ‘Apple’ may refer to a kind of fruits, a company, or any other suitable entity. For these reasons, identifying entities unambiguously in a document may be a challenging task for the social-networking system. However, the ability to identify entities in documents may allow the social-networking system to improve the quality of search results considerably, providing the technical advantages of, for example, reducing the number of documents that need to be retrieved in response to a given search query and/or improving the relevance of retrieved documents. The social-networking system may prepare a knowledge base constructed based on a large corpus of text collected from a reference source. An entity-linking system in the social-networking system may access a document to identify mentions and their corresponding entities in the document. First, the entity-linking system may identify mentions appearing in the document by parsing the document. The entity-linking system may identify all the possible candidate entities for each identified mention by looking up the identified mention from the knowledge base. The entity-linking system may calculate a confidence score for each candidate entity for each identified mention by analyzing the text by a machine-learning disambiguation model. The entity-linking system may determine a candidate entity with a highest confidence score among the candidate entities for the mention as the referenced entity by the mention. The entity-linking system may produce a mention-entity pair for each unique and non-redundant mention in the document. As an example and not by way of limitation, the entity-linking system may access a document containing a sentence, “Michael Jordan is a professor at UC Berkeley” to identify mentions and their corresponding referenced entities. The entity-linking system may identify “Michael Jordan,” “Professor,” “at,” “UC,” “Berkeley,” and “UC Berkeley” as mentions appearing in the sentence. The entity-linking system may determine that “Michael Jordan” may refer to a former NBA basketball player, a professor at UC Berkeley working in machine learning, or some other person with the name by looking up “Michael Jordan” in the knowledge base. The entity-linking system may analyze the sentence using a machine learning model. Since the sentence also contains “Professor” and “UC Berkeley,” the confidence score for the professor at UC Berkeley as the corresponding entity for “Michael Jordan” is higher than the confidence score for the former basketball player. The entity-linking system may produce {“Michael Jordan,” “unique entity identifier for the professor at UC Berkeley” }, {“Professor,” “Unique entity identifier for a profession teaching at a college or university” }, {“UC Berkeley,” “Unique entity identifier for the California public school located in Berkeley” } as mention-entity pairs identified in the document. Although this disclosure describes identifying entities referenced by mentions in a document in a particular manner, this disclosure contemplates identifying entities referenced by mentions in a document in any suitable manner.

In particular embodiments, the social-networking system may access a document comprising one or more sentences, wherein each of the one or more sentences comprises a plurality of tokens. The social-networking system may identify one or more noun phrases in the document by performing a pre-processing on the accessed document. The social-networking system may generate, for each identified noun phrase, a list of candidate entities corresponding to the noun phrase, wherein the list of candidate entities is looked up in an entity index using the noun phrase, wherein the entity index comprises identifiers of a plurality of entities corresponding to a plurality of noun phrases. The social-networking system may compute, for each candidate entity corresponding to each identified noun phrase, a confidence score that the noun phrase is intended to reference the candidate entity by analyzing the accessed document by a machine learning model. The social-networking system may construct a pool of mention-entity pairs for the accessed document, wherein a mention-entity pair for an identified noun phrase comprises the noun phrase and an identifier for an entity referenced by the noun phrase, and wherein the pool of mention-entity pairs for the accessed document comprises mention-entity pairs for all the unique and non-redundant identified noun phrases in the accessed document. The social-networking system may filter the pool of mention-entity pairs by removing each mention-entity pair from the pool based on their computed confidence scores. The social-networking system may store the post-filtered pool of mention-entity pairs in a data store in association with the accessed document.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example view of an embedding space.

FIG. 4 illustrates an example artificial neural network.

FIG. 5 illustrates an example structure of the entity-linking system.

FIG. 6 illustrates example functionalities for each module in the set of entity-linking modules.

FIGS. 7A-7B illustrate an example scenario for computing degrees of coherency between pairs of candidate entities.

FIG. 8 illustrates an example method for identifying entities referenced in a document.

FIG. 9 illustrates an example computer system.

### DESCRIPTION OF EXAMPLE EMBODIMENTS

### System Overview

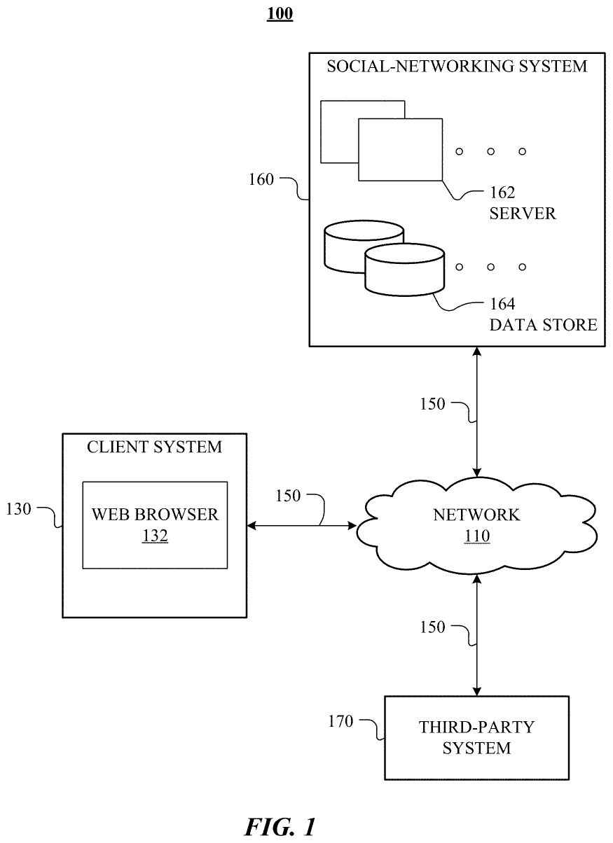

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes-which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

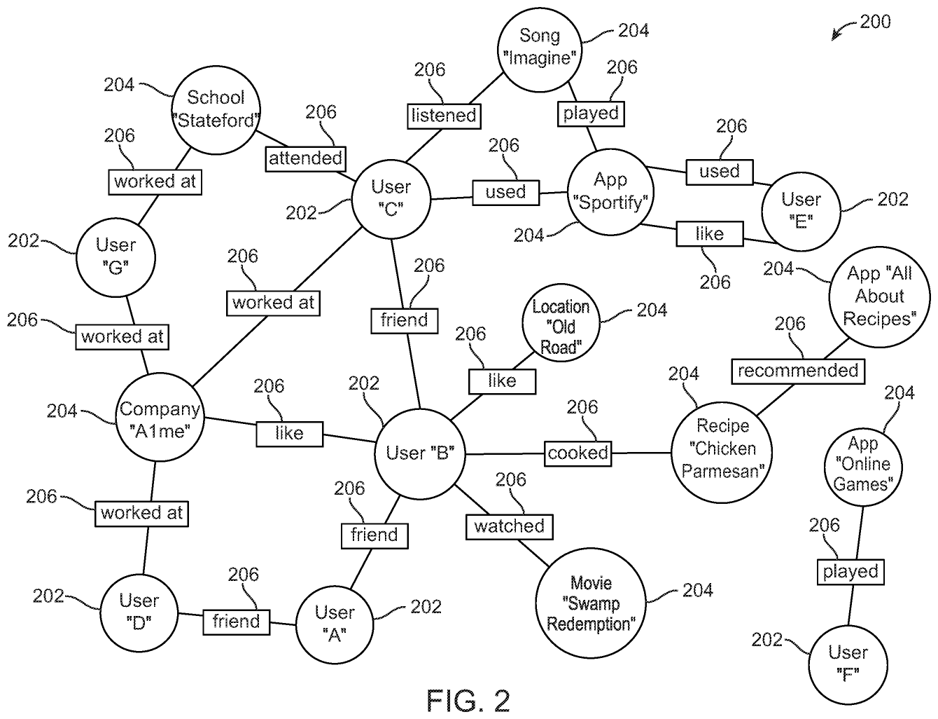

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. Each node may be associated with a unique entity (i.e., user or concept), each of which may have a unique identifier (ID), such as a unique number or username. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other inter-actable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206. The degree of separation between two objects represented by two nodes, respectively, is a count of edges in a shortest path connecting the two nodes in the social graph 200. As an example and not by way of limitation, in the social graph 200, the user node 202 of user “C” is connected to the user node 202 of user “A” via multiple paths including, for example, a first path directly passing through the user node 202 of user “B,” a second path passing through the concept node 204 of company “Acme” and the user node 202 of user “D,” and a third path passing through the user nodes 202 and concept nodes 204 representing school “Stanford,” user “G,” company “Acme,” and user “D.” User “C” and user “A” have a degree of separation of two because the shortest path connecting their corresponding nodes (i.e., the first path) includes two edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries on Online Social Networks

In particular embodiments, the social-networking system 160 may receive, from a client system of a user of an online social network, a query inputted by the user. The user may submit the query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

### Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763,162, filed 19 Apr. 2010, and U.S. patent application Ser. No. 13/556,072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, and U.S. patent application Ser. No. 12/978,265, filed 23 Dec. 2010, which are incorporated by reference.

### Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556,072, filed 23 Jul. 2012, U.S. patent application Ser. No. 13/731,866, filed 31 Dec. 2012, and U.S. patent application Ser. No. 13/732,101, filed 31 Dec. 2012, each of which is incorporated by reference. More information on structured search queries and grammar models may be found in U.S. patent application Ser. No. 13/556,072, filed 23 Jul. 2012, U.S. patent application Ser. No. 13/674,695, filed 12 Nov. 2012, and U.S. patent application Ser. No. 13/731,866, filed 31 Dec. 2012, each of which is incorporated by reference.

### Generating Keywords and Keyword Queries

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. patent application Ser. No. 14/244,748, filed 3 Apr. 2014, U.S. patent application Ser. No. 14/470,607, filed 27 Aug. 2014, and U.S. patent application Ser. No. 14/561,418, filed 5 Dec. 2014, each of which is incorporated by reference.

### Vector Spaces and Embeddings

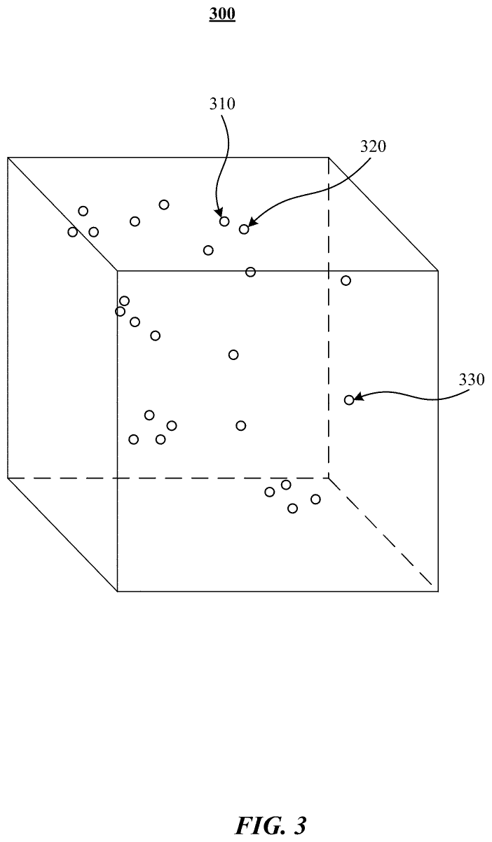

FIG. 3 illustrates an example view of a vector space 300. In particular embodiments, an object or an n-gram may be represented in a d-dimensional vector space, where d denotes any suitable number of dimensions. Although the vector space 300 is illustrated as a three-dimensional space, this is for illustrative purposes only, as the vector space 300 may be of any suitable dimension. In particular embodiments, an n-gram may be represented in the vector space 300 as a vector referred to as a term embedding. Each vector may comprise coordinates corresponding to a particular point in the vector space 300 (i.e., the terminal point of the vector). As an example and not by way of limitation, vectors 310, 320, and 330 may be represented as points in the vector space 300, as illustrated in FIG. 3. An n-gram may be mapped to a respective vector representation. As an example and not by way of limitation, n-grams t₁ and t₂ may be mapped to vectors [symbol] and [symbol] in the vector space 300, respectively, by applying a function [symbol] defined by a dictionary, such that [symbol] = [symbol] (t₁) and [symbol] = [symbol] (t₂). As another example and not by way of limitation, a dictionary trained to map text to a vector representation may be utilized, or such a dictionary may be itself generated via training. As another example and not by way of limitation, a model, such as Word2vec, may be used to map an n-gram to a vector representation in the vector space 300. In particular embodiments, an n-gram may be mapped to a vector representation in the vector space 300 by using a machine leaning model (e.g., a neural network). The machine learning model may have been trained using a sequence of training data (e.g., a corpus of objects each comprising n-grams).

In particular embodiments, an object may be represented in the vector space 300 as a vector referred to as a feature vector or an object embedding. As an example and not by way of limitation, objects e₁ and e₂ may be mapped to vectors [symbol] and [symbol] in the vector space 300, respectively, by applying a function [symbol] , such that [symbol] = [symbol] (e₁) and [symbol] = [symbol] (e₂). In particular embodiments, an object may be mapped to a vector based on one or more properties, attributes, or features of the object, relationships of the object with other objects, or any other suitable information associated with the object. As an example and not by way of limitation, a function [symbol] may map objects to vectors by feature extraction, which may start from an initial set of measured data and build derived values (e.g., features). As an example and not by way of limitation, an object comprising a video or an image may be mapped to a vector by using an algorithm to detect or isolate various desired portions or shapes of the object. Features used to calculate the vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. As another example and not by way of limitation, an object comprising audio data may be mapped to a vector based on features such as a spectral slope, a tonality coefficient, an audio spectrum centroid, an audio spectrum envelope, a Mel-frequency cepstrum, or any other suitable information. In particular embodiments, when an object has data that is either too large to be efficiently processed or comprises redundant data, a function [symbol] may map the object to a vector using a transformed reduced set of features (e.g., feature selection). In particular embodiments, a function [symbol] may map an object e to a vector [symbol] (e) based on one or more n-grams associated with object e. Although this disclosure describes representing an n-gram or an object in a vector space in a particular manner, this disclosure contemplates representing an n-gram or an object in a vector space in any suitable manner.

In particular embodiments, the social-networking system 160 may calculate a similarity metric of vectors in vector space 300. A similarity metric may be a cosine similarity, a Minkowski distance, a Mahalanobis distance, a Jaccard similarity coefficient, or any suitable similarity metric. As an example and not by way of limitation, a similarity metric of [symbol] and [symbol] may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric of [symbol] and [symbol] may be a Euclidean distance ∥ [symbol] − [symbol] ∥. A similarity metric of two vectors may represent how similar the two objects or n-grams corresponding to the two vectors, respectively, are to one another, as measured by the distance between the two vectors in the vector space 300. As an example and not by way of limitation, vector 310 and vector 320 may correspond to objects that are more similar to one another than the objects corresponding to vector 310 and vector 330, based on the distance between the respective vectors. Although this disclosure describes calculating a similarity metric between vectors in a particular manner, this disclosure contemplates calculating a similarity metric between vectors in any suitable manner.

More information on vector spaces, embeddings, feature vectors, and similarity metrics may be found in U.S. patent application Ser. No. 14/949,436, filed 23 Nov. 2015, U.S. patent application Ser. No. 15/286,315, filed 5 Oct. 2016, and U.S. patent application Ser. No. 15/365,789, filed 30 Nov. 2016, each of which is incorporated by reference.

### Artificial Neural Networks

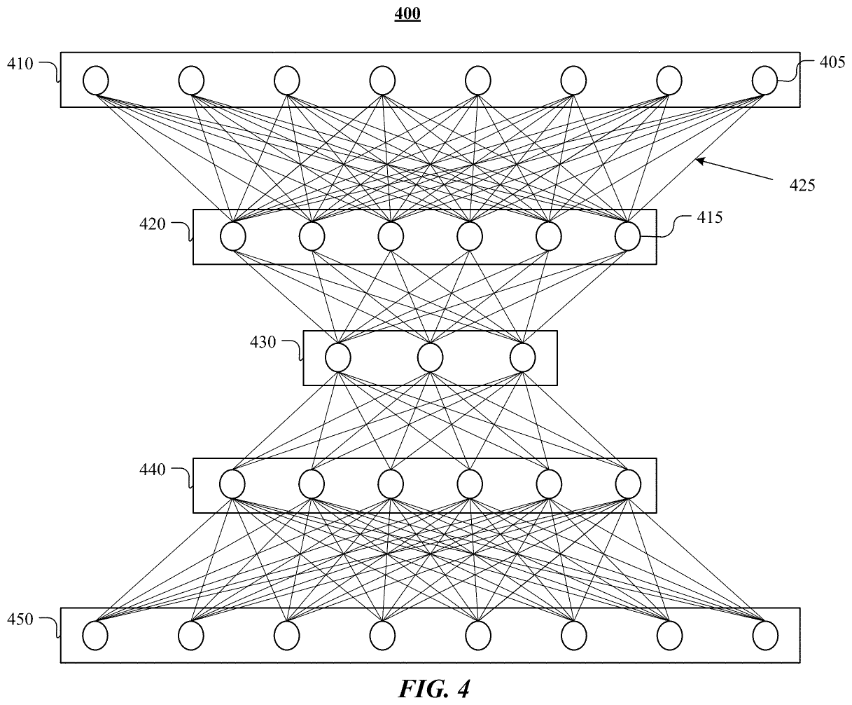

FIG. 4 illustrates an example artificial neural network (“ANN”) 400. In particular embodiments, an ANN may refer to a computational model comprising one or more nodes. Example ANN 400 may comprise an input layer 410, hidden layers 420, 430, 440, and an output layer 450. Each layer of the ANN 400 may comprise one or more nodes, such as a node 405 or a node 415. In particular embodiments, each node of an ANN may be connected to another node of the ANN. As an example and not by way of limitation, each node of the input layer 410 may be connected to one of more nodes of the hidden layer 420. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 4 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 4 depicts a connection between each node of the input layer 410 and each node of the hidden layer 420, one or more nodes of the input layer 410 may not be connected to one or more nodes of the hidden layer 420.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 420 may comprise the output of one or more nodes of the input layer 410. As another example and not by way of limitation, the input to each node of the output layer 450 may comprise the output of one or more nodes of the hidden layer 440. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(sₖ)=max(0,sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 425 between the node 405 and the node 415 may have a weighting coefficient of 0.4, which may indicate that 0.4 multiplied by the output of the node 405 is used as an input to the node 415. As another example and not by way of limitation, the output yₖ of node k may be yₖ=Fₖ(sₖ), where Fₖ may be the activation function corresponding to node k, sₖ=Σⱼ (wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 400 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to back propagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

### Entity Linking in Documents

In particular embodiments, the social-networking system 160 may identify name strings, also called as mentions, referring to entities in a document. The social-networking system 160 may link the identified mentions to the most appropriate corresponding entities for use in resolving search queries. A mention and a corresponding entity may not always be one-to-one mapped. An entity may be referred to by various names (i.e., a many-to-one mapping). As an example and not by way of limitation, New York City may be called by ‘New York City,’ ‘New York,’ ‘NY,’ ‘NYC,’ or even by ‘the Big Apple.’ Furthermore, a mention may be linked to more than one entity (i.e., a one-to-many mapping). As an example and not by way of limitation, a mention ‘Apple’ may refer to a kind of fruits, a company, or any other suitable entity. For these reasons, identifying entities unambiguously in a document may be a challenging task for the social-networking system 160. However, the ability to identify entities in documents may allow the social-networking system 160 to improve the quality of search results considerably, providing the technical advantages of, for example, reducing the number of documents that need to be retrieved in response to a given search query and/or improving the relevance of retrieved documents. The social-networking system 160 may prepare a knowledge base constructed based on a large corpus of text collected from a reference source. An entity-linking system in the social-networking system 160 may access a document to identify mentions and their corresponding entities in the document. First, the entity-linking system may identify mentions appearing in the document by parsing the document. The entity-linking system may identify all the possible candidate entities for each identified mention by looking up the identified mention from the knowledge base. The entity-linking system may calculate a confidence score for each candidate entity for each identified mention by analyzing the text by a machine-learning disambiguation model. The entity-linking system may determine a candidate entity with a highest confidence score among the candidate entities for the mention as the referenced entity by the mention. The entity-linking system may produce a mention-entity pair for each unique and non-redundant mention in the document. As an example and not by way of limitation, the entity-linking system may access a document containing a sentence, “Michael Jordan is a professor at UC Berkeley” to identify mentions and their corresponding referenced entities. The entity-linking system may identify “Michael Jordan,” “Professor,” “at,” “UC,” “Berkeley,” and “UC Berkeley” as mentions appearing in the sentence. The entity-linking system may determine that “Michael Jordan” may refer to a former NBA basketball player, a professor at UC Berkeley working in machine learning, or some other person with the name by looking up “Michael Jordan” in the knowledge base. The entity-linking system may analyze the sentence using a machine learning model. Since the sentence also contains “Professor” and “UC Berkeley,” the confidence score for the professor at UC Berkeley as the corresponding entity for “Michael Jordan” is higher than the confidence score for the former basketball player. The entity-linking system may produce {“Michael Jordan,” “unique entity identifier for the professor at UC Berkeley” }, {“Professor,” “Unique entity identifier for a profession teaching at a college or university” }, {“UC Berkeley,” “Unique entity identifier for the California public school located in Berkeley” } as mention-entity pairs identified in the document. Although this disclosure describes identifying entities referenced by mentions in a document in a particular manner, this disclosure contemplates identifying entities referenced by mentions in a document in any suitable manner.

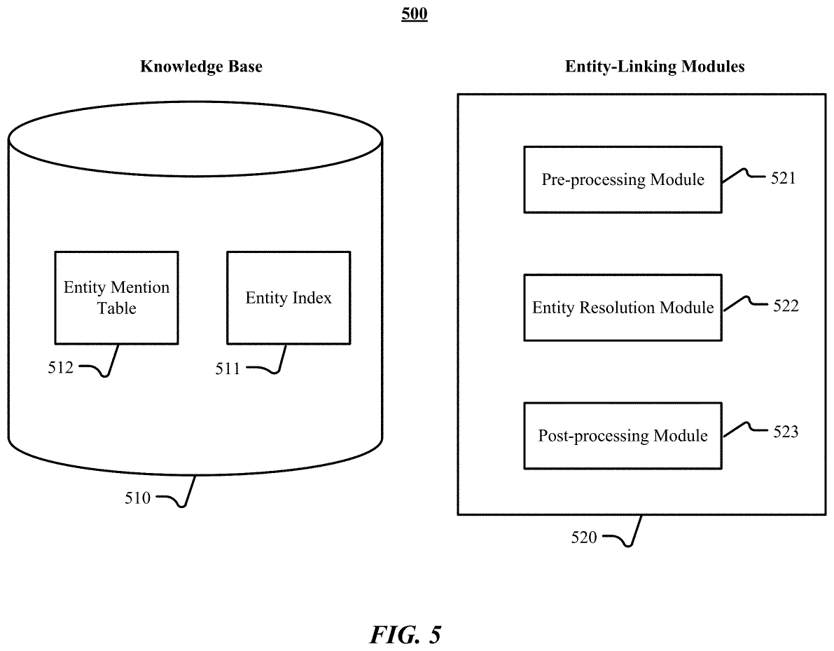

FIG. 5 illustrates an example structure of the entity-linking system 500. The entity-linking system 500, a part of the social-networking system 160, may be responsible for linking entities in documents. The entity-linking system 500 may comprise a knowledge base 510 and a set of entity-linking modules 520. In particular embodiments, the social-networking system 160 may construct the knowledge base comprising an entity index 511 and an entity mention table 512 by analyzing a corpus of text collected from a reference source with a machine learning model. The entity index 511 may comprise one or more links to entities in the entity mention table 512 for each noun phrase. The entity mention table 512 may comprise a plurality of metadata records. Each metadata record may comprise an identifier that uniquely identifies an entity, a domain the entity belongs to, a list of connected entities, and a count representing a number of social signals associated with the entity on an online social network. In particular embodiments, the set of entity-linking modules 520 may comprise a pre-processing module 521, an entity resolution module 522, and a post-processing module 523. Although this disclosure describes a particular structure for the entity-linking system, this disclosure contemplates any suitable structure for the entity-linking system.

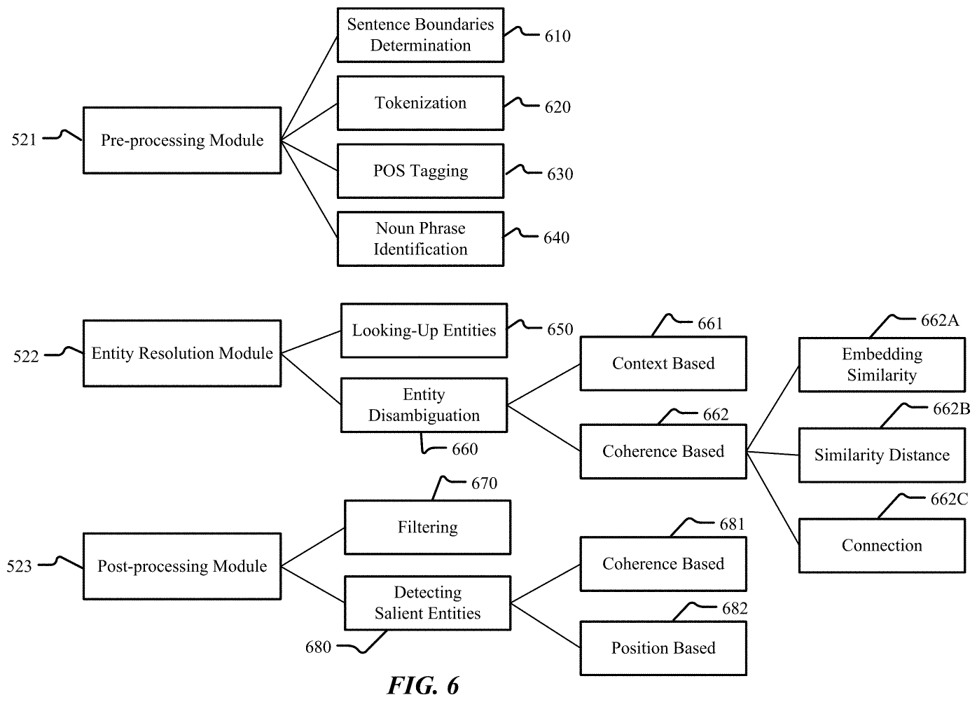

FIG. 6 illustrates example functionalities for each module in the set of entity-linking modules 520. The pre-processing module 521 may determine sentence boundaries 610, perform a tokenization 620, tag parts-of-speech (POS) to tokens 630, and identify noun phrases 640. The entity resolution module 522 may look up entities 650 and perform an entity disambiguation 660. The entity resolution module 522 may perform the entity disambiguation 660 based on context 661 and coherence 662 between noun phrases. The coherence 662 between two noun phrases may be determined based on a similarity between embeddings corresponding to the noun phrases 662A, based on a similarity distance 662B, or based on connections between the noun phrases 662C in a reference source. The post-processing module 523 may perform a filtering 670 and detect salient entities 680. The post-processing module 523 may detect salient entities 680 based on coherence 681 or based on positions of respective noun phrases 682. Although this disclosure describes particular functionalities of the entity-linking modules, this disclosure contemplates any suitable functionalities of the entity-linking modules.

In particular embodiments, the social-networking system 160 may access a document comprising one or more sentences. The social-networking system 160 may forward the accessed document to the entity-linking system 500 to identify entities referenced in the document. Each of the one or more sentences may comprise a plurality of tokens. A subset of the plurality of tokens may be a part of noun phrases. As an example and not by way of limitation, an online social network user may upload a posting to her timeline. The posting may comprise a sentence “Michael Jordan is a professor at UC Berkeley.” Before storing the posting to a data store, the social-networking system 160 may forward the posting to the entity-linking system 500. After the entity-linking system 500 identifies entities referenced in the posting, the posting may be stored in a data store. The identified entities may also be stored in a data store in association with the posting. Although this disclosure describes accessing a document for identifying entities referenced in the document in a particular manner, this disclosure contemplates accessing a document for identifying entities referenced in the document in any suitable manner.

In particular embodiments, the pre-processing module 521 of the entity-linking system 500 may identify one or more noun phrases in the document by performing a pre-processing on the accessed document. During the pre-processing, the pre-processing module 521 may determine boundaries of the sentences for the one or more sentences 610. For each of the one or more sentences, the pre-processing module 521 may identify a plurality of tokens belonging to the sentence by performing a tokenization 620. The pre-processing module 521 may assign a parts-of-speech (POS) tag to each identified token 630. A POS tag assigned to a token may be based on a definition of the token and based on a context of the token, i.e., relationship of the token with adjacent and related tokens in a phrase, sentence, or paragraph of the document. The pre-processing module 521 may identify one or more noun phrases from each of the one or more sentences based on the POS tag assigned to the tokens of the sentence. As an example and not by way of limitation, continuing with a prior example, the entity-linking system 500 may provide the posting to the pre-processing module 521 as input. The pre-processing module 521 may determine boundaries of sentences in the posting. Thus, the pre-processing module 521 may determine a token string “Michael Jordan is a professor at UC Berkeley.” As a sentence. The pre-processing module 521 may perform a tokenization on each of the determined sentences. The pre-processing module 521 may identify ‘Michael,’ ‘Jordan,’ ‘is,’ ‘a,’ ‘professor,’ ‘at,’ ‘UC,’ and ‘Berkeley’ as tokens in the sentence “Michael Jordan is a professor at UC Berkeley.” The pre-processing module 521 may assign a POS tag to each of the identified tokens. Finally, the pre-processing module 521 may identify one or more noun phrases from each of the determined sentences based on the POS tags assigned to the tokens of the sentence. The pre-processing module 521 may identify “Michael Jordan,” “Professor,” “at,” “UC,” “Berkeley,” and “UC Berkeley” as noun phrases in the sentence “Michael Jordan is a professor at UC Berkeley.” Although this disclosure describes identifying noun phrases from a document in a particular manner, this disclosure contemplates identifying noun phrases from a document in any suitable manner.

In particular embodiments, the entity resolution module 522 of the entity-linking system 500 may generate a list of candidate entities corresponding to each of the identified noun phrases. The entity resolution module 520 may utilize the entity look-up function 650 to generate the list of candidate entities. The entity resolution module 522 may look up an identified noun phrase in the entity index 511 of the knowledge base 510 to generate the list of candidate entities for the identified noun phrase. The entity index 511 may comprise identifiers of a plurality of entities corresponding to a plurality of noun phrases. As an example and not by way of limitation, continuing with a prior example, the entity resolution module 522 may generate a list of candidate entities for ‘Michael Jordan’ by looking up ‘Michael Jordan’ in the entity index 511. The list of candidate entities may comprise a former National Basketball Association (NBA) basketball player, an actor, a scientist, and more individuals. The entity resolution module 522 may generate a list of candidate entities for the other identified noun phrases as well. Although this disclosure describes generating a list of candidate entities for a noun phrase in a particular manner, this disclosure contemplates generating a list of candidate entities for a noun phrase in any suitable manner.

In particular embodiments, the entity resolution module 522 of the entity-linking system 500 may compute, for each candidate entity corresponding to each identified noun phrase, a confidence score that the noun phrase is intended to reference the candidate entity in the document by analyzing the accessed document by a machine learning model. The entity resolution module 522 may utilize the entity disambiguation function 660 to compute the confidence score. A confidence score for a candidate entity corresponding to an identified noun phrase in a document may be computed based on a context 661. In particular embodiments, the confidence score for the candidate entity corresponding to the identified noun phrase in the document may be computed based on coherence 662. Although this disclosure describes computing a confidence score for a candidate entity corresponding to an identified noun phrase in a document in a particular manner, this disclosure contemplates computing the confidence score for the candidate entity corresponding to the identified noun phrase in the document in any suitable manner.

In particular embodiments, the entity resolution module 522 of the entity-linking system 500 may identify one or more neighboring tokens for each identified noun phrase within a pre-determined distance of the noun phrase in the document. Each of the identified one or more neighboring tokens may belong to a sentence different from the sentence that the identified noun phrase belongs to. The entity resolution module 522 may determine a representation indicating a context for each of the identified noun phrases based on the identified neighboring tokens for the noun phrase. The representation indicating the context for the identified noun phase may be an embedding constructed based on word embeddings corresponding to the identified neighboring tokens for the identified noun phrase. An embedding may be a representation indicating a point in a d-dimensional embedding space. The entity resolution module 522 may provide the determined representation for each identified noun phrase to the machine learning model as input. The machine learning model may produce the confidence scores for the candidate entities corresponding to each identified noun phrase as output by computing the confidence scores based on the provided determined representation indicating the context for the noun phrase. In particular embodiments, the entity resolution module 522 may determine any suitable representation indicating the context for each of the identified noun phrases other than an embedding. As an example and not by way of limitation, continuing with a prior example, the entity resolution module 522 may identify a plurality of neighboring tokens that are within a pre-determined distance from the noun phrase ‘Michael Jordan.’ Some of the identified neighboring tokens may not belong to the sentence “Michael Jordan is a professor at UC Berkeley.” Still, tokens from the neighboring sentences may represent the context for ‘Michael Jordan.’ The entity resolution module 522 may determine word embeddings corresponding to the identified tokens. The entity resolution module 522 may construct an embedding based on the determined word embeddings corresponding to the identified tokens. In particular embodiments, the entity resolution module 522 may take an average of the word embeddings to construct the embedding representing the context. The entity resolution module 522 may provide the constructed embedding to the machine learning model as input. The machine learning model may compute a confidence score for each candidate entity for the noun phrase ‘Michael Jordan’ based on the provided embedding. The machine learning model may produce the computed confidence scores for the candidate entities for the noun phrase ‘Michael Jordan’ as output. The entity resolution module 522 may determine a representation indicating a context for each of the identified noun phrases and provide the determined representations to the machine learning model as input. Although this disclosure describes computing confidence scores for candidate entities corresponding to a noun phrase based on a context for the noun phrase in a particular manner, this disclosure contemplates computing confidence scores for candidate entities corresponding to a noun phrase based on a context for the noun phrase in any suitable manner.

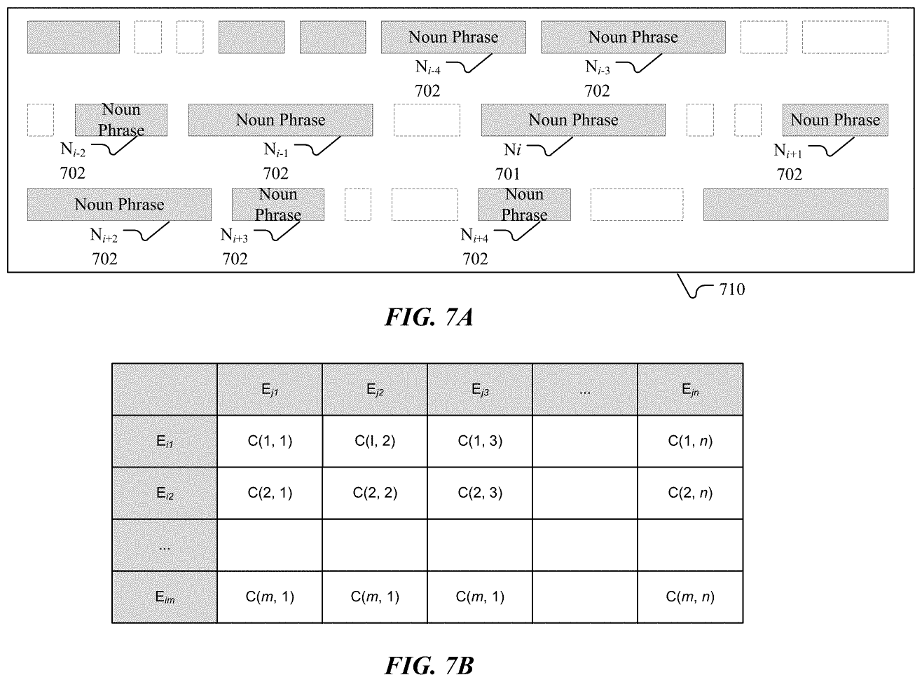

FIGS. 7A-7B illustrate an example scenario for computing degrees of coherency between pairs of candidate entities. In particular embodiments, the entity resolution module 522 may compute a degree of coherency for each pair of candidate entities corresponding to each pair of noun phrases within a predetermined distance. The entity resolution module 522 may provide the computed degrees of coherency to the machine learning model as input. FIG. 7A illustrates a part of a document 710 that comprises a plurality of identified noun phrases. The grayed boxes illustrate the identified noun phrases. The dotted clear boxed illustrate tokens that are not a part of any noun phrase. The entity resolution module 522 may access an identified noun phrase Nᵢ 701 as a first noun phrase. The entity resolution module 522 may determine, for the noun phrase Nᵢ 701, a set of neighboring noun phrases appearing within a distance k, a pre-determined number, of the noun phrase Nᵢ 701 in the document 710. The determined set of neighboring noun phrases for an identified noun phrase Nᵢ 701 may comprise k preceding noun phrases and k following noun phrases from the identified noun phrase Nᵢ 701 in the document. The pre-determined number k in the example illustrated in FIG. 7A is 4. Thus, the set of neighboring noun phrases 702 for the noun phrase Nᵢ 701 would be {Nᵢ₋₄, Nᵢ₋₃, Nᵢ₋₂, Nᵢ₋₁, Nᵢ₊₁, Nᵢ₊₂, Nᵢ₊₃, Nᵢ₊₄}. For each pair of the identified noun phrase Nᵢ 701 and a noun phrase Nⱼ in the set of neighboring noun phrases 702, the entity resolution module 522 may identify all possible combination pairs of a first candidate entity Eᵢₓ corresponding to the identified noun phrase Nᵢ 701 and a second candidate entity E_{jy} corresponding to the neighboring noun phrase Nⱼ in the set of neighboring noun phrases 702 for the identified noun phrase Nᵢ 701. FIG. 7B illustrates an example combinations of candidate entities for noun phrases Nᵢ and Nⱼ. The noun phrase Nᵢ is associated with m candidate entities (Eᵢ₁, Eᵢ₂, . . . , Eᵢₘ) while the noun phrase Nⱼ is associated with n candidate entities (Eⱼ₁, Eⱼ₂, Eⱼ₃, . . . , Eⱼₙ). The entity resolution module 522 may compute, for each pair of a first candidate entity Eᵢₓ and a second candidate entity E_{jy}, a degree of coherency C(x, y). The entity resolution module 522 may provide the computed degrees of coherency {C(1, 1), C(1, 2), C(1, 3), . . . C(1, n), . . . , C(m, n)} for all the possible pairs of the first candidate entity Eᵢₓ and the second candidate entity E_{jy} to the machine learning model as input. The machine learning model may compute the confidence scores for the candidate entities corresponding to each identified noun phrase based on the provided computed degrees of coherency for all the possible pairs of candidate entities corresponding to identified noun phrases within the distance k. Although this disclosure describes computing the confidence scores based on degrees of coherency between pairs of candidate entities corresponding to a pair of noun phrases within a distance in a particular manner, this disclosure contemplates computing the confidence scores based on degrees of coherency between pairs of candidate entities corresponding to a pair of noun phrases within a distance in any suitable manner.

In particular embodiments, the entity resolution module 522 may compute the degree of coherency for each pair of the first candidate entity Eᵢₓ and the second candidate entity E_{jy} based on a similarity between an embedding corresponding to the first candidate entity and an embedding corresponding to the second candidate entity. The first candidate entity Eᵢₓ may correspond to an identified noun phrase Nᵢ, and the second candidate entity E_{jy} may correspond to an identified noun phrase Nⱼ, where the distance between Nᵢ and Nⱼ is less than or equal to the pre-determined distance k. The entity resolution module 522 may determine embeddings corresponding to the first candidate entity Eᵢₓ and the second candidate entity E_{jy}. The entity resolution module 522 may calculate a similarity between an embedding corresponding to the first candidate entity Eᵢₓ and an embedding corresponding to the second candidate entity E_{jy}. The entity resolution module 522 may compute the degree of coherency based on the calculated similarity. As described above, the entity resolution module 522 may provide the computed degree of coherency to the machine learning model as input. As an example and not by way of limitation, continuing with a prior example, the entity resolution module 522 may compute degrees of coherency between candidate entities corresponding to ‘Michael Jordan’ and candidate entities corresponding to ‘professor’ as the two noun phrases are within the pre-determined distance based on similarities in embedding space. For the sake of brevity, the entity resolution module 522 has identified three candidate entities for ‘Michael Jordan’: “a former NBA basketball player,” “an actor,” and “a scientist, professor at the University of California, Berkeley,” and identified one candidate entity “an academic rank at universities and other post-secondary education and research institutions” for the noun phrase ‘professor.’ The entity resolution module 522 may compute a cosign similarity between an embedding corresponding to a candidate entity “a former NBA basketball player” and an embedding corresponding to a candidate entity “an academic rank at universities and other post-secondary education and research institutions.” The entity resolution module 522 may also compute a cosign similarity between an embedding corresponding to a candidate entity “an actor” and the embedding corresponding to the candidate entity “an academic rank at universities and other post-secondary education and research institutions,” and a cosign similarity between an embedding corresponding to a candidate entity “a scientist, professor at the University of California, Berkeley” and the embedding corresponding to the candidate entity “an academic rank at universities and other post-secondary education and research institutions.” The entity resolution module 522 may compute the degrees of coherency based on the calculated similarities. The entity resolution module 522 may also compute cosign similarities for all the possible combination pairs of a first candidate entity Eᵢₓ corresponding to a first identified noun phrase Nᵢ and a second candidate entity E_{jy} corresponding to a second identified noun phrase N where the distance between Nᵢ and Nⱼ is less than or equal to the pre-determined distance k in the posting. Although this disclosure describes computing a degree of coherency based on a similarity in an embedding space in a particular manner, this disclosure contemplates computing a degree of coherency based on a similarity in an embedding space in any suitable manner.

In particular embodiments, the entity resolution module 522 may compute the degree of coherency for each pair of the first candidate entity Eᵢₓ and the second candidate entity E_{jy} based on a similarity distance between the first candidate entity Eᵢₓ and the second candidate entity E_{jy}. A similarity distance may be a semantic similarity measure derived from the number of hits returned by a search engine for a given pair of candidate entities. The first candidate entity Eᵢₓ may be a candidate entity for a noun phrase Nᵢ and the second candidate entity E_{jy} may be a candidate entity for a noun phrase Nⱼ where the distance between Nᵢ and Nⱼ is less than or equal to the pre-determined distance k in the document. In particular embodiments, the similarity distance may be a google similarity distance. The entity resolution module 522 may compute the degree of coherency based on the computed similarity distance. The entity resolution module 522 may provide the computed degree of coherency to the machine learning model as input. As an example and not by way of limitation, continuing with a prior example, the entity resolution module 522 may compute degrees of coherency between candidate entities corresponding to ‘Michael Jordan’ and candidate entities corresponding to ‘professor’ based on google similarity distances between candidate entities. The entity resolution module 522 may compute a google similarity distance between a candidate entity “a former NBA basketball player” and a candidate entity “an academic rank at universities and other post-secondary education and research institutions.” The entity resolution module 522 may also compute a google similarity distance between a candidate entity “an actor” and the candidate entity “an academic rank at universities and other post-secondary education and research institutions,” and a google similarity distance between a candidate entity “a scientist, professor at the University of California, Berkeley” and the candidate entity “an academic rank at universities and other post-secondary education and research institutions.” The entity resolution module 522 may compute the degrees of coherency based on the calculated google similarity distances. The entity resolution module 522 may also compute google similarity distances for all the possible combination pairs of a first candidate entity Eᵢₓ corresponding to a first identified noun phrase Nᵢ and a second candidate entity E_{jy} corresponding to a second identified noun phrase Nⱼ where the distance between Nᵢ and Nⱼ is less than or equal to the pre-determined distance k in the posting. Although this disclosure describes computing a degree of coherency based on a similarity distance in a particular manner, this disclosure contemplates computing a degree of coherency based on a similarity distance in any suitable manner.

In particular embodiments, the entity resolution module 522 may compute the degree of coherency for each pair of the first candidate entity Eᵢₓ and the second candidate entity E_{jy} based on whether a page corresponding to the first candidate entity Eᵢₓ in a reference source comprises a link to a page corresponding to the second candidate entity E_{jy} in the reference source, and vice versa. The first candidate entity Eᵢₓ may correspond to an identified noun phrase Nᵢ in the document, and the second candidate entity E_{jy} may correspond to an identified noun phrase Nⱼ in the document, where the distance between Nᵢ and Nⱼ is less than or equal to the pre-determined distance k in the document. The entity resolution module 522 may determine whether a page corresponding to the first candidate entity Eᵢₓ in a reference source comprises a link to a page corresponding to the second candidate entity E_{jy} in the reference source. The entity resolution module 522 may also determine whether the page corresponding to the second candidate entity E_{jy} in the reference source comprises a link to the page corresponding to the first candidate entity Eᵢₓ in the reference source. The entity resolution module 522 may compute the degree of coherency based on the determinations. The entity resolution module 522 may provide the computed degree of coherency to the machine learning model as input. As an example and not by way of limitation, continuing with a prior example, the entity resolution module 522 may compute degrees of coherency between candidate entities corresponding to ‘Michael Jordan’ and candidate entities corresponding to ‘professor’ based on whether corresponding Wikipedia pages have links to each other. The entity resolution module 522 may determine whether a Wikipedia page corresponding to a candidate entity “a former NBA basketball player” has a link to a Wikipedia page corresponding to a candidate entity “an academic rank at universities and other post-secondary education and research institutions,” and vice versa. The entity resolution module 522 may also determine whether a Wikipedia page corresponding to a candidate entity “an actor” has a link to a Wikipedia page corresponding to the candidate entity “an academic rank at universities and other post-secondary education and research institutions,” and vice versa. The entity resolution module 522 may also determine whether a Wikipedia page corresponding to a candidate entity “a scientist, professor at the University of California, Berkeley” has a link to a Wikipedia page corresponding to the candidate entity “an academic rank at universities and other post-secondary education and research institutions,” and vice versa. The entity resolution module 522 may compute the degrees of coherency based on the determinations. The entity resolution module 522 may also determine whether Wikipedia pages for the first candidate entity Eᵢₓ and the second candidate entity E_{jy} have links to each other for all the possible combination pairs of a first candidate entity Eᵢₓ corresponding to a first identified noun phrase Nᵢ and a second candidate entity E_{jy} corresponding to a second identified noun phrase Nⱼ where the distance between Nᵢ and Nⱼ is less than or equal to the pre-determined distance k in the posting. Although this disclosure describes computing a degree of coherency based on whether pages corresponding to a pair of candidate entities in a reference source have links to each other in a particular manner, this disclosure contemplates computing a degree of coherency based on whether pages corresponding to a pair of candidate entities in a reference source have links to each other in any suitable manner.

In particular embodiments, the entity resolution module 522 may construct a pool of mention-entity pairs for the accessed document. A mention-entity pair for an identified noun phrase may comprise the noun phrase and an identifier for an entity referenced by the noun phrase. The entity resolution module 522 may determine an entity with a highest computed confidence score among the corresponding candidate entities for an identified noun phrase as the entity referenced by the noun phrase. The pool of mention-entity pairs for the accessed document may comprise mention-entity pairs for all the unique and non-redundant identified noun phrases in the accessed document. As an example and not by way of limitation, continuing with a prior example, the entity resolution module 522 may compute confidence scores for all the candidate entities corresponding to each identified noun phrase in the document. The entity resolution module 522 may determine a candidate entity with a highest computed confidence score among the candidate entities corresponding to an identified noun phrase as an entity referenced by the identified noun phrase. The entity resolution module 522 may construct a pool of mention-entity pairs comprising all the unique and non-redundant noun phrases and the entities referenced by respective noun phrases. The pool of mention-entity pairs constructed from the sentence “Michael Jordan is a professor at UC Berkeley.” in the posting may comprise {‘Michael Jordan’, “a scientist, professor at the University of California, Berkeley” }, {‘professor’, “an academic rank at universities and other post-secondary education and research institutions” }, {‘at’, “an Internet country code top-level domain for Austria” }, and {“UC Berkeley”, “a public research university in Berkeley, Calif.” }. The pool of mention-entity pairs may also comprise other noun phrases and their corresponding referenced entities identified from the other sentences in the posting. Although this disclosure describes constructing a pool of mention-entity pairs for a document in a particular manner, this disclosure contemplates constructing a pool of mention-entity pairs for a document in any suitable manner.

In particular embodiments, the post-processing module 523 of the entity-linking system 500 may filter the pool of mention-entity pairs by removing each mention-entity pair from the pool based on their computed confidence scores. The post-processing module 523 may determine, for each mention-entity pair in the pool, whether the computed confidence score that the noun phrase in the mention-entity pair is intended to reference the entity in the mention-entity pair is lower than a threshold. In response to the determination for each pair, the post-processing module 523 may remove the pair from the pool of mention-entity pairs. As an example and not by way of limitation, continuing with a prior example, the post-processing module 523 may determine that the computed confidence score for the noun phrase ‘at’ is intended to reference an entity “an Internet country code top-level domain for Austria” in the posting is lower than the threshold score. ‘At’ is used as a preposition, not as a noun phrase in the sentence. The post-processing module 523 may remove the mention-entity pair for ‘at’ from the pool of mention-entity pairs. Although this disclosure describes filtering the pool of mention-entity pairs in a particular manner, this disclosure contemplates filtering the pool of mention-entity pairs in any suitable manner.

In particular embodiments, the social-networking system 160 may store the post-filtered pool of mention-entity pairs in a data store in association with the accessed document. The social-networking system 160 may utilize the post-filtered pool of mention-entity pairs stored in the data store when the social-networking system 160 maps a search query to documents. In particular embodiments, the social-networking system 160 may map a search query to the document if the search query comprises one or more entities in the pool of mention-entity pairs. To achieve that, the social-networking system 160 may perform an entity-linking on a received search query when the social-networking system 160 receives the search query. If any linked entity in the search query matches one or more entities in the post-filtered pool of mention-entity pairs, the social-networking system 160 may map the search query to the accessed document. As an example and not by way of limitation, continuing with a prior example, the social-networking system 160 may receive a search query “Dr. Jordan working on machine learning.” After performing an entity-linking procedure on the received search query, the social-networking system 160 may determine that ‘Dr. Jordan’ is referencing ‘Michael Jordan’ who is a scientist, professor at the University of California, Berkeley. The social-networking system 160 may map the search query to the stored posting. Although this disclosure describes utilizing the stored pool of mention-entity pairs in a particular manner, this disclosure contemplates utilizing the stored pool of mention-entity pairs in any suitable manner.

In particular embodiments, the post-processing module 523 may identify one or more salient entities in the pool of mention-entity pairs. The one or more salient entities may represent a main idea of the document better than the other entities in the pool. The social-networking system 160 may store the identified one or more salient entities in a data store in association with the accessed document. The social-networking system 160 may utilize the identified one or more salient entities stored in the data store when the social-networking system 160 maps a search query to documents. In particular embodiments, the social-networking system 160 may map a search query to the document if the search query comprises one or more salient entities. The social-networking system 160 may rank a document high when the social-networking system 160 processes a search query if the search query comprises one or more salient entities for the document. Although this disclosure describes utilizing identified one or more salient entities in a particular manner, this disclosure contemplates utilizing identified one or more salient entities in any suitable manner.

In particular embodiments, the post-processing module 523 may compute a degree of coherency for each pair of entities in the pool. The post-processing module 523 may determine a salience score for each entity in the pool based on the computed degrees of coherency to the other entities in the pool. The determined salience score for an entity in the pool may be higher than the other entities in the pool if a sum of the degrees of coherency between the entity and the other entities in the pool is higher than any sum of the degrees of coherency for any other entities in the pool. The post-processing module 523 may identify the one or more salient entities based on the determined salience scores corresponding to the entities in the pool. Although this disclosure describes identifying salient entities for a document based on computed degrees of coherency in a particular manner, this disclosure contemplates identifying salient entities for a document based on computed degrees of coherency in any suitable manner.

In particular embodiments, the post-processing module 523 may identify, for each entity in the pool, one or more positions in the document that the corresponding noun phrase appears. The post-processing module 523 may determine a salience score for each entity in the pool based on the identified one or more positions of the corresponding noun phrase in the documents. The salience score for the entity may be higher if the one or more identified positions are in a beginning of the document or in an ending of the document than an entity whose corresponding noun phrase appears only in a middle of the document. The post-processing module 523 may identify the one or more salient entities based on the determined salience scores. Although this disclosure describes identifying salient entities for a document based on positions of corresponding noun phrases in the document computed degrees of coherency in a particular manner, this disclosure contemplates identifying salient entities for a document based on positions of corresponding noun phrases in the document in any suitable manner.

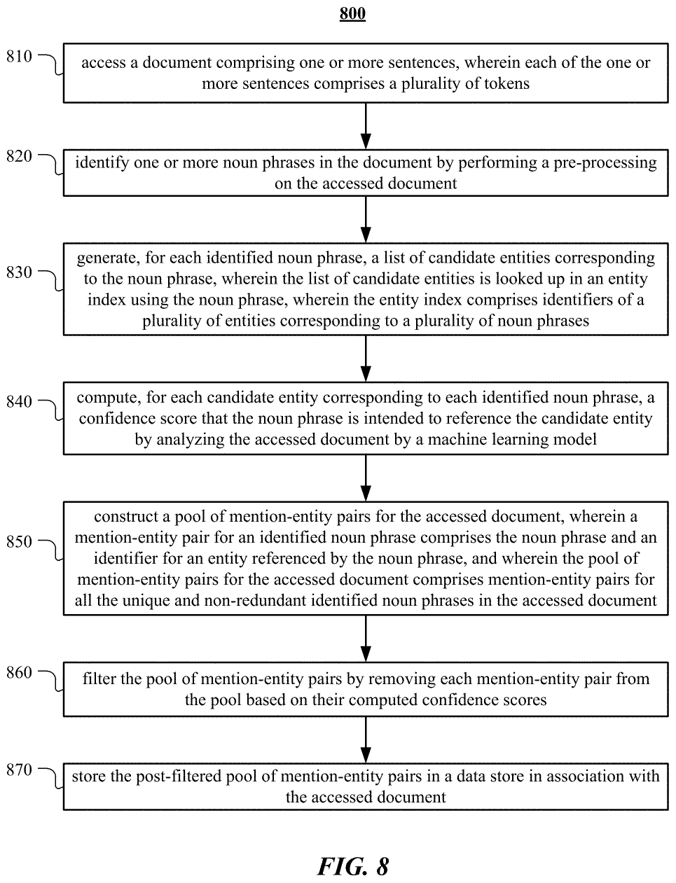

FIG. 8 illustrates an example method 800 for identifying entities referenced in a document. The method may begin at step 810, where the social-networking system 160 may access a document comprising one or more sentences, wherein each of the one or more sentences comprises a plurality of tokens. At step 820, the social-networking system 160 may identify one or more noun phrases in the document by performing a pre-processing on the accessed document. At step 830, the social-networking system 160 may generate, for each identified noun phrase, a list of candidate entities corresponding to the noun phrase, wherein the list of candidate entities is looked up in an entity index using the noun phrase, wherein the entity index comprises identifiers of a plurality of entities corresponding to a plurality of noun phrases. At step 840, the social-networking system 160 may compute, for each candidate entity corresponding to each identified noun phrase, a confidence score that the noun phrase is intended to reference the candidate entity by analyzing the accessed document by a machine learning model. At step 850, the social-networking system 160 may construct a pool of mention-entity pairs for the accessed document, wherein a mention-entity pair for an identified noun phrase comprises the noun phrase and an identifier for an entity referenced by the noun phrase, and wherein the pool of mention-entity pairs for the accessed document comprises mention-entity pairs for all the unique and non-redundant identified noun phrases in the accessed document. At step 860, the social-networking system 160 may filter the pool of mention-entity pairs by removing each mention-entity pair from the pool based on their computed confidence scores. At step 870, the social-networking system 160 may store the post-filtered pool of mention-entity pairs in a data store in association with the accessed document. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for identifying entities referenced in a document including the particular steps of the method of FIG. 8, this disclosure contemplates any suitable method for identifying entities referenced in a document including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

More information on entity-linking processes may be found in U.S. patent application Ser. No. 15/355,500, filed 18 Nov. 2016, and U.S. patent application Ser. No. 15/827,622, filed 30 Nov. 2017, each of which are incorporated by reference.

### Social Graph Affinity and Coefficient

In particular embodiments, the social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, the social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile interfaces, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, the social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, the social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, the social-networking system 160 may calculate a coefficient based on a user's actions. The social-networking system 160 may monitor such actions on the online social network, on a third-party system 170, on other suitable systems, or any combination thereof. Any suitable type of user actions may be tracked or monitored. Typical user actions include viewing profile interfaces, creating or posting content, interacting with content, tagging or being tagged in images, joining groups, listing and confirming attendance at events, checking-in at locations, liking particular interfaces, creating interfaces, and performing other tasks that facilitate social action. In particular embodiments, the social-networking system 160 may calculate a coefficient based on the user's actions with particular types of content. The content may be associated with the online social network, a third-party system 170, or another suitable system. The content may include users, profile interfaces, posts, news stories, headlines, instant messages, chat room conversations, emails, advertisements, pictures, video, music, other suitable objects, or any combination thereof. The social-networking system 160 may analyze a user's actions to determine whether one or more of the actions indicate an affinity for subject matter, content, other users, and so forth. As an example and not by way of limitation, if a user frequently posts content related to “coffee” or variants thereof, the social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile interface for the second user.

In particular embodiments, the social-networking system 160 may calculate a coefficient based on the type of relationship between particular objects. Referencing the social graph 200, the social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, the social-networking system 160 may determine that the user has a higher coefficient with respect to the first photo than the second photo because having a tagged-in-type relationship with content may be assigned a higher weight and/or rating than having a like-type relationship with content. In particular embodiments, the social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, the social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, the social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, the social-networking system 160 may determine that the user has a higher coefficient for the airport than the gas station based on the proximity of the airport to the user.

In particular embodiments, the social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, the social-networking system 160 may provide information that is relevant to user's interests and current circumstances, increasing the likelihood that they will find such information of interest. In particular embodiments, the social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, the social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results interface than results corresponding to objects having lower coefficients.

In particular embodiments, the social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, the social-networking system 160 may calculate the coefficient (or access the coefficient information if it has previously been calculated and stored). In particular embodiments, the social-networking system 160 may measure an affinity with respect to a particular process. Different processes (both internal and external to the online social network) may request a coefficient for a particular object or set of objects. The social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Advertising

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more web interfaces, in one or more e-mails, or in connection with search results requested by a user. In addition or as an alternative, an advertisement may be one or more sponsored stories (e.g., a news-feed or ticker item on the social-networking system 160). A sponsored story may be a social action by a user (such as “liking” an interface, “liking” or commenting on a post on an interface, RSVPing to an event associated with an interface, voting on a question posted on an interface, checking in to a place, using an application or playing a game, or “liking” or sharing a website) that an advertiser promotes, for example, by having the social action presented within a pre-determined area of a profile interface of a user or other interface, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results interface, where sponsored content is promoted over non-sponsored content.

In particular embodiments, an advertisement may be requested for display within social-networking-system web interfaces, third-party web interfaces, or other interfaces. An advertisement may be displayed in a dedicated portion of an interface, such as in a banner area at the top of the interface, in a column at the side of the interface, in a GUI within the interface, in a pop-up window, in a drop-down menu, in an input field of the interface, over the top of content of the interface, or elsewhere with respect to the interface. In addition or as an alternative, an advertisement may be displayed within an application. An advertisement may be displayed within dedicated interfaces, requiring the user to interact with or watch the advertisement before the user may access an interface or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) an interface associated with the advertisement. At the interface associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, the social-networking system 160 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through the social-networking system 160) or RSVP (e.g., through the social-networking system 160) to an event associated with the advertisement. In addition or as an alternative, an advertisement may include social-networking-system content directed to the user. As an example and not by way of limitation, an advertisement may display information about a friend of the user within the social-networking system 160 who has taken an action associated with the subject matter of the advertisement.

### Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile interface that identify a set of users that may access the work experience information on the user-profile interface, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by the social-networking system 160 or shared with other systems (e.g., a third-party system 170). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and may only be sent to the user (or a client system 130 of the user) if the authorization server determines that the user is authorized to access the object based on the privacy settings associated with the object. If the requesting user is not authorized to access the object, the authorization server may prevent the requested object from being retrieved from the data store 164, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

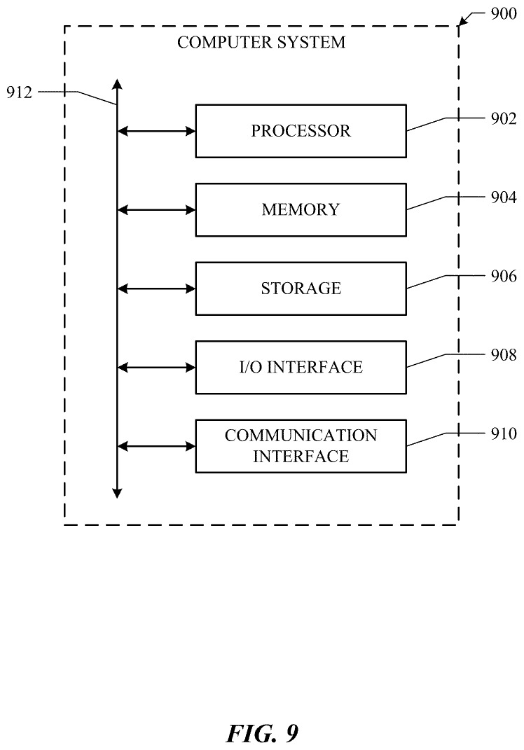

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (IO) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, IO interface 908 includes hardware, software, or both, providing one or more interfaces for communication between computer system 900 and one or more IO devices. Computer system 900 may include one or more of these IO devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
accessing, by the one or more computing systems, a document comprising one or more sentences, wherein each of the one or more sentences comprises a plurality of tokens;
identifying, by the one or more computing systems, one or more noun phrases in the document by performing a pre-processing on the accessed document;
generating, by the one or more computing systems, for each identified noun phrase, a list of candidate entities corresponding to the noun phrase, wherein the list of candidate entities is looked up in an entity index using the noun phrase, wherein the entity index comprises identifiers of a plurality of entities corresponding to a plurality of noun phrases;
computing, by the one or more computing systems, for each candidate entity corresponding to each identified noun phrase, a confidence score that the noun phrase is intended to reference the candidate entity by analyzing the accessed document by a machine learning model;
constructing, by the one or more computing systems, a pool of mention-entity pairs for the accessed document, wherein a mention-entity pair for an identified noun phrase comprises the noun phrase and an identifier for an entity referenced by the noun phrase, and wherein the pool of mention-entity pairs for the accessed document comprises mention-entity pairs for all the unique and non-redundant identified noun phrases in the accessed document;
filtering, by the one or more computing systems, the pool of mention-entity pairs by removing each mention-entity pair from the pool based on their computed confidence scores; and
storing, by the one or more computing systems, the post-filtered pool of mention-entity pairs in a data store in association with the accessed document.

2. The method of claim 1, wherein performing the pre-processing on the accessed document comprises:
determining, for each of the one or more sentences, boundaries of the sentence;
identifying, for each of the one or more sentences, a plurality of tokens belonging to the sentence by performing a tokenization;
assigning, to each identified token, a parts-of-speech (POS) tag using a POS-tagger module; and
identifying, from each of the one or more sentences, one or more noun phrases based on the POS tag assigned to the tokens of the sentence.

3. The method of claim 1, wherein a knowledge base comprises the entity index and an entity mention table, wherein the entity index comprises one or more links to candidate entities in the entity mention table for each noun phrase, and wherein the entity mention table comprises a plurality of metadata records, each metadata record comprising an identifier that uniquely identifies an entity, a domain the entity belongs to, a list of connected entities, and a count representing a number of social signals associated with the entity on an online social network.

4. The method of claim 3, wherein the knowledge base is constructed by analyzing a corpus of text collected from a reference source with a machine learning model.

5. The method of claim 1, further comprising:
identifying, by the one or more computing systems, for each identified noun phrase, one or more neighboring tokens within a pre-determined distance of the noun phrase in the document,
determining, by the one or more computing systems, for each identified noun phrase, a representation indicating a context for the identified noun phrase based on the identified neighboring tokens; and
providing, by the one or more computing systems, to the machine learning model, the determined representation for each identified noun phrase as input.

6. The method of claim 5, wherein the representation indicating the context for the identified noun phase is an embedding constructed based on word embeddings corresponding to the identified neighboring tokens for the identified noun phrase, wherein an embedding is a representation indicating a point in a d-dimensional embedding space.

7. The method of claim 1, further comprising, for each identified noun phrase of the plurality of identified noun phrases:
determining, by the one or more computing systems, for the identified noun phrase, a set of neighboring noun phrases appearing within a distance k of the noun phrase in the document, wherein the determined set of neighboring noun phrases comprises k preceding noun phrases and k following noun phrases from the identified noun phrases in the document, and wherein k is a pre-determined number;
identifying, by the one or more computing systems, for the identified noun phrase and for a neighboring noun phrase in the determined set of neighboring noun phrases, all possible combination pairs of a first candidate entity corresponding to the identified noun phrase and a second candidate entity for the neighboring noun phrase;
computing, by the one or more computing systems, for each pair of a first candidate entity and a second candidate entity, a degree of coherency; and
providing, by the one or more computing systems, to the machine learning model, the computed degrees of coherency for all the possible pairs of the first candidate entity and the second candidate entity as input.

8. The method of claim 7, wherein computing the degree of coherency for each pair of the first candidate entity and the second candidate entity comprises:
determining embeddings corresponding to the first candidate entity and the second candidate entity;
calculating a similarity between an embedding corresponding to the first candidate entity and an embedding corresponding to the second candidate entity; and
computing the degree of coherency based on the calculated similarity.

9. The method of claim 7, wherein computing the degree of coherency for each pair of the first candidate entity and the second candidate entity comprises:
computing a similarity distance between the first candidate entity and the second candidate entity; and
computing the degree of coherency based on the computed similarity distance.

10. The method of claim 7, wherein computing the degree of coherency for each pair of the first candidate entity and the second candidate entity comprises:
determining whether a page corresponding to the first candidate entity in a reference source comprises a link to a page corresponding to the second candidate entity in the reference source;
determining whether the page corresponding to the second candidate entity in the reference source comprises a link to the page corresponding to the first candidate entity in the reference source; and
computing the degree of coherency based on the determinations.

11. The method of claim 1, wherein an entity with a highest computed confidence score among the corresponding candidate entities for an identified noun phrase is determined as the entity referenced by the noun phrase.

12. The method of claim 1, wherein filtering the pool of mention-entity pairs comprises:
determining, for each mention-entity pair in the pool, whether the computed confidence score that the noun phrase in the mention-entity pair is intended to reference the entity in the mention-entity pair is lower than a threshold; and
removing, in response to the determination for each pair, the pair from the pool of mention-entity pairs.

13. The method of claim 1, wherein the post-filtered pool of mention-entity pairs stored in the data store is utilized when mapping a search query to documents is performed.

14. The method of claim 13, wherein a search query is mapped to the document if the search query comprises one or more entities in the pool of mention-entity pairs.

15. The method of claim 1, further comprising:
identifying, by the one or more computing systems, one or more salient entities in the pool of mention-entity pairs, wherein the one or more salient entities represent a main idea of the document better than the other entities in the pool; and
storing, by the one or more computing systems, the identified one or more salient entities in a data store in association with the accessed document.

16. The method of claim 15, wherein identifying the one or more salient entities in the pool of mention-entity pairs comprises:
computing, for each pair of entities in the pool, a degree of coherency to each other;
determining, for each entity in the pool, a salience score based on the computed degrees of coherency to the other entities in the pool; and
identifying the one or more salient entities based on the determined salience scores corresponding to the entities in the pool.

17. The method of claim 15, wherein identifying the one or more salient entities in the pool of mention-entity pairs comprises:
identifying, for each entity in the pool, one or more positions in the document that the corresponding noun phrase appears;
determining, for each entity in the pool, a salience score based on the identified one or more positions of the corresponding noun phrase in the documents, wherein the salience score for the entity is higher if the one or more identified positions are in a beginning of the document or in an ending of the document than an entity whose corresponding noun phrase appears only in a middle of the document; and
identifying the one or more salient entities based on the determined salience scores.

18. The method of claim 15, wherein the identified one or more salient entities stored in the data store are utilized when mapping a search query to documents is performed.

19. One or more computer-readable non-transitory storage media embodying software that is operable when executed to:
access a document comprising one or more sentences, wherein each of the one or more sentences comprises a plurality of tokens;
identify one or more noun phrases in the document by performing a pre-processing on the accessed document;
generate, for each identified noun phrase, a list of candidate entities corresponding to the noun phrase, wherein the list of candidate entities is looked up in an entity index using the noun phrase, wherein the entity index comprises identifiers of a plurality of entities corresponding to a plurality of noun phrases;
compute, for each candidate entity corresponding to each identified noun phrase, a confidence score that the noun phrase is intended to reference the candidate entity by analyzing the accessed document by a machine learning model;
construct a pool of mention-entity pairs for the accessed document, wherein a mention-entity pair for an identified noun phrase comprises the noun phrase and an identifier for an entity referenced by the noun phrase, and wherein the pool of mention-entity pairs for the accessed document comprises mention-entity pairs for all the unique and non-redundant identified noun phrases in the accessed document;
filter the pool of mention-entity pairs by removing each mention-entity pair from the pool based on their computed confidence scores; and
store the post-filtered pool of mention-entity pairs in a data store in association with the accessed document.

20. A system comprising: one or more processors; and a non-transitory memory coupled to the processors comprising instructions executable by the processors, the processors operable when executing the instructions to:
access a document comprising one or more sentences, wherein each of the one or more sentences comprises a plurality of tokens;
identify one or more noun phrases in the document by performing a pre-processing on the accessed document;
generate, for each identified noun phrase, a list of candidate entities corresponding to the noun phrase, wherein the list of candidate entities is looked up in an entity index using the noun phrase, wherein the entity index comprises identifiers of a plurality of entities corresponding to a plurality of noun phrases;
compute, for each candidate entity corresponding to each identified noun phrase, a confidence score that the noun phrase is intended to reference the candidate entity by analyzing the accessed document by a machine learning model;
construct a pool of mention-entity pairs for the accessed document, wherein a mention-entity pair for an identified noun phrase comprises the noun phrase and an identifier for an entity referenced by the noun phrase, and wherein the pool of mention-entity pairs for the accessed document comprises mention-entity pairs for all the unique and non-redundant identified noun phrases in the accessed document;
filter the pool of mention-entity pairs by removing each mention-entity pair from the pool based on their computed confidence scores; and
store the post-filtered pool of mention-entity pairs in a data store in association with the accessed document.
